(19) United States
(12) Patent Application Publication
(10) Pub. No.: US 2008/0184170 A1
(43) Pub. Date: Jul. 31, 2008

(54) SYSTEMS AND METHODS FOR CUSTOMIZED INSTANT MESSAGING APPLICATION FOR DISPLAYING STATUS OF MEASUREMENTS FROM SENSORS

(75) Inventor: Shalini Periyalwar, Ottawa (CA)

Correspondence Address: Shalini Periyalwar, 88 Summerwalk Place, Ottawa, ON, K2G 5Y4, omitted

(73) Assignee: SHAPE innovations inc, Ottawa (CA)

(21) Appl. No.: 12/015,504

(22) Filed: Jan. 16, 2008

Related U.S. Application Data
(60) Provisional application No. 60/885,124, filed on Jan. 16, 2007.

(51) Int. Cl. G06F 3/048; G06F 15/00

(52) U.S. Cl. 715/841; 702/188

(57) ABSTRACT

Some embodiments of customized instant messaging application for displaying status of measurements from sensors are proposed. These include: simultaneous use of multiple avatars for a given source where one or more of the avatars represent sensor presence; selective assignment of avatar and associated presence information to recipients; dynamic changes to avatar triggered by changes to sensor measurements representing a noticeable change in environment being monitored; selective display of data in customized messaging application based on defined roles and responsibilities of recipient; dismissal of avatar update notification only after necessary action following change to presence condition induced by sensor.

### FIELD OF THE INVENTION

The present invention generally relates to the field of communication using presence information such as in Instant Messaging (IM) applications, more specifically to customizing the presence enabled messaging application to various end-user markets which require real-time access to the status of measurements corresponding to important changes in environments or assets being monitored by sensor systems.

### BACKGROUND OF THE INVENTION

### Instant Messaging and Presence

Instant messaging (IM) is a popular communication tool. The tool is currently generic and is being used extensively for both office and personal communications, mainly for interactive chat. A unique attribute of communicating with IM is the availability of presence information in the form of a visual display of an icon (termed “avatar”) associated with the user, along with some indication of the user's availability on the network. IM is not commonly used for man-machine interaction.

FIG. 1 illustrates a conventional IM application screen. Typically, there are one or more categories of contacts. In this example, there are three categories of contacts—friends, family and co-workers. Thus the same IM tool is used for both personal and office communications. The address book folder contains email addresses of all the contacts. The small (smiley) image or icon beside the IM user's email address (johndoe@customizedIM.com) is called the “avatar”; one of several avatars in the IM library can be picked by the user. There is only one avatar per user in an IM session and this avatar is published to all the members of a user's IM group. The message beside the email address indicates that John Doe's state is set to “busy”. This basic presence information is manually modified by John Doe. The purpose of the avatar and the presence condition is to inform the members of the IM group about the user's availability status. Also, extended presence information may include a personalized message by John Doe to indicate that he is “taking a nap”. Optionally, the avatar may be automatically changed to reflect the user's mood, based on some local information, e.g., the type of music the user is listening to. Any change made by the user to the presence information is published to the entire IM group including family, friends and co-workers. Any member of the user's IM group (unless explicitly blocked by the user) can see the change to the presence condition if the member has the IM application window open. If the member is not actively engaged in IM, as long as the group member has the IM application active, the presence condition update is reported with a brief popup window on the member's screen, notifying the member of a change in presence condition for a given member in his IM group.

IM applications from different vendors (e.g., Yahoo Messenger, Google talk, MSN Messenger) contain other customized features, such as access to music files, etc. Users may somewhat customize the IM application to their taste, e.g., by changing icons.

The most common protocol standards in use for communications between IM applications include the Open Source IETF XMPP protocol and the SIP SIMPLE protocol. A number of proprietary protocols are also in use. Any of these protocols support the transmission of published presence information. Sensor systems for monitoring environments and assets Sensors are finding increasing application in remote measurement of critical conditions and will likely be widely deployed in the coming years to serve a range of functions such as security, monitoring of various items, conditions, events and occurrences such as assets, environment, mobility, health, power outages, etc. Sensors will thus play an important role in a variety of vertical markets ranging from company laboratories to law enforcement and healthcare. The display of sensor generated data is realized with a Graphical User Interface (GUI) specific to the sensor application. The transmission of remote sensor measurement information to an interested party or stakeholder is achieved through various generic communication technologies (e.g., email, SMS, and IM chat) or a proprietary communication protocol between the sensor system server and the user end application. When transmitted through IM chat, the information is conveyed textually within the body of the IM message field.

The need for monitoring sensor status via a separate sensor data application implies the introduction of additional load on the user's resources (computing, time) in an environment where most users are already struggling with information overload. The information overload issue may also result in the stakeholder inadvertently missing out on the sensor update received through email or other communications. This in turn may result in the user delaying access to time-critical information, which may produce undesirable consequences including danger to individuals and/or assets being monitored and potentially irreversible outcomes. In situations of emergency requiring communication of time critical information, the use of proprietary communication protocols or a two-step approach where sensor measurements are monitored by a service provider who subsequently attempts reaching stakeholders via phone, email, SMS or IM text communication, may not be practical. Further, notification of critical events through the ordinary means of communication may be ignored or forgotten when the end-user is interrupted while pursuing other tasks on his computing device (e.g., desktop or laptop computer, smartphone).

The availability of presence as a basic feature in IM and the need for efficient access to time-critical sensor generated information are the main drivers for the embodiments described in this invention.

### SUMMARY OF THE INVENTION

In one broad aspect, a method and system are provided for displaying different avatars from a set of generic and custom avatars, for different member sub-groups in the messaging application User Interface (UI).

In one broad aspect, a method and system are provided for automatically changing a selected avatar and associated extended presence condition published only to a predefined subset of recipients.

In one broad aspect, a method and system are provided for linking status of measurements from sensors to automatically modify extended presence information.

In one broad aspect, a method and system are provided for displaying reminders and alerts related to the sensor measurements on the messaging application UI.

In one broad aspect, a method and system are provided for displaying further details on sensor measurements within a custom folder in the messaging application UI.

In one broad aspect, a method and system are provided to ensure that critical changes to presence conditions are acted upon before the presence update notification is dismissed from the recipient's screen.

In one broad aspect, a method and system are provided for creating a communication interface between the messaging application and the sensor measurement database at the sensor location.

In one broad aspect, a method and system are provided for creating a communication interface between the messaging application and the sensor measurement database server in the network.

In one broad aspect, a method and system are provided for creating a communication interface between the messaging application and the sensor measurement database at the recipient.

In one broad aspect, a method and system are provided to convey interested parties or stakeholders with the current medical condition of a patient using the messaging application.

In one broad aspect, a method and system are provided to provide business continuity teams with the current facility condition using the messaging application.

In some embodiments, machine and/or machine+user presence is provided rather than conventional user presence. A concise information display on a commonly used messaging application may be used to provide busy end-users with quick and convenient access to critical information. This solution will reduce information overload stress on busy end-users. In some embodiments, the use of a complementary message communication path improves probability of message reception.

In some embodiments, end-users without customized messaging application or sensor management application installed can still have access to basic presence status with visible change to the avatar (e.g., top executives in a company get near-real-time update on facility presence status on their generic messaging application, while the business continuity planning team responsible for all aspects of smooth functioning in an emergency get the details with their customized messaging application and sensor management application). In some cases, this is achieved by including these users as members of the custom group to which the custom avatar is made available. In some embodiments, this class of user only sees the avatar and not the details in the custom folder.

### BRIEF DESCRIPTION OF THE DRAWINGS

Embodiments of the invention will now be described with reference to the attached drawings in which:

FIG. 1 presents a generic version of the current IM messaging display;

FIG. 2 presents a schematic diagram of the system architecture for remote sensor monitoring using a communication network (e.g., cellular);

FIG. 3 presents a schematic diagram of the general system architecture in accordance with an embodiment of the invention;

FIG. 4 presents the customized IM UI for displaying sensor measurements at the local and remote location in accordance with an embodiment of the invention;

FIG. 5 is a flowchart of a method of using customized IM displays to convey remote sensor monitoring information; and

FIG. 6 is a block diagram of an example of customized IM applications for conveying remote sensor monitoring information.

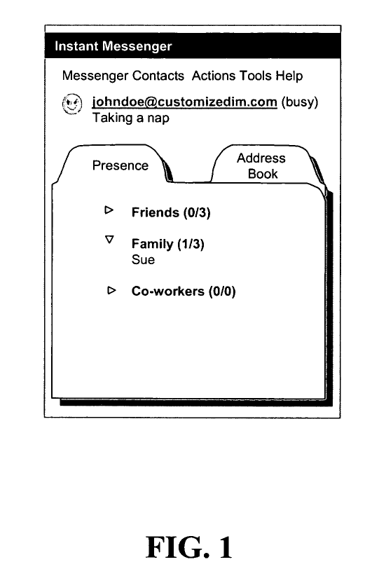

### DETAILED DESCRIPTION OF THE PREFERRED EMBODIMENTS

Multiple Avatars and Presence Information from user to Different Recipients

In some embodiments, systems and methods are provided that allow for multiple avatars to be implemented for a given user, with each avatar designated to sub-groups of contacts. This allows for customization of presence information to be sent to each sub-group.

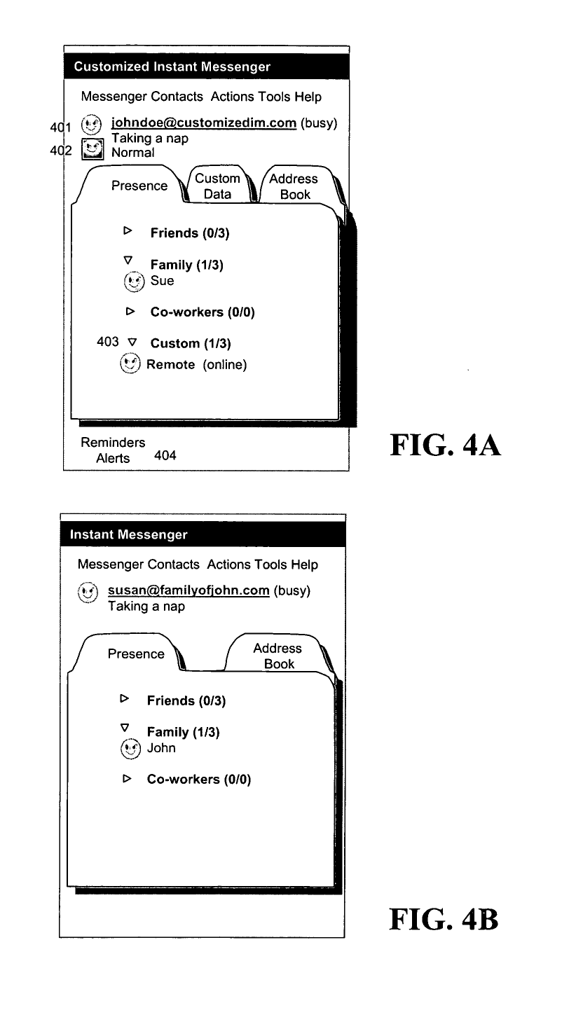

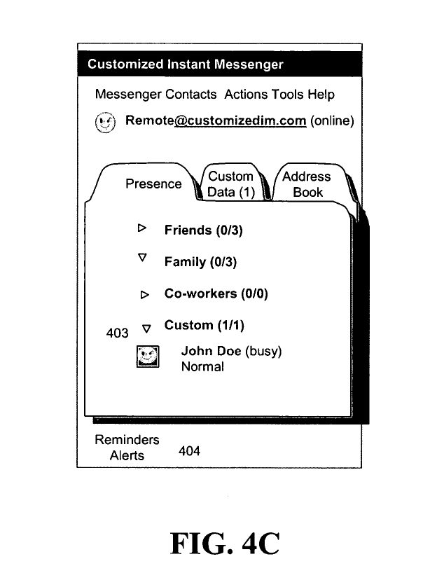

FIGS. 4(a) shows a customized IM UI for a first user “John Doe”. FIG. 4(b) shows an IM UI for a second user “Susan” that in this case is a conventional IM UI. FIG. 4(c) shows a customized IM UI for a third user “custom”.

In FIG. 4(a), the IM for John Doe has two avatars (401, 402), one of which is custom (402), therefore visible only to the members of the custom sub-group (403) identified by John Doe. More generally, there may be any number of avatars and corresponding custom sub-groups. In some embodiments, the custom avatar and the accompanying message (shown as “Normal”) is modified automatically on the basis of the readings from sensors that are associated with John. Optionally, the custom avatar may be manually managed by John Doe. The IM also shows presence information for Friends, Family—this including Susan, and co-workers. The generic avatar for Susan is displayed. Finally, there is presence information for a single sub-group “custom” that includes “remote”. Since remote does not have a custom avatar, the generic avatar for remote is displayed.

In FIG. 4(b), the avatar for Susan is shown at the top. The presence information includes Friends, Family—this including John, and co-workers. The generic avatar for John is displayed since Susan does not belong to the select group of custom members identified by John.

In FIG. 4(c) , the avatar for “remote” is shown at the top. User “remote” does not have a custom avatar in this example, simply because he has chosen to have just a generic avatar. If he did create a custom avatar for a subset of custom members, those members would then see his custom avatar and others would see his generic avatar. The presence information includes Friends, Family, co-workers. There is also presence information for a single sub-group “custom” that includes John Doe. In this case, the custom avatar 402 (FIG. 4(a) ) is shown for John Doe.

In this manner, John Doe is able to publish different avatars to different sub-groups of contacts identified by him. Each of John Doe's avatars is accompanied by unique presence information. Susan, a contact of John Doe, is the recipient of the generic avatar (along with presence information corresponding to the avatar—Busy, Taking a nap), while “remote”, another contact of John Doe, is the recipient of the custom avatar (along with presence information corresponding to that avatar—Normal).

Also in FIG. 4(a) and FIG. 4(c), the reminders and alerts (404) from the sensor system that John Doe is associated with, are visible on the IM UI. The custom folder in FIG. 4(a) contains John's local sensor readings. The custom folder in FIG. 4(c) contains a summary of John's sensor readings accessible at the remote end. “Remote” has as many custom folders as there are members in his sub-group, i.e., “Remote” could have multiple members in his custom sub-group, and therefore receive custom data from multiple sources, with each source having a separate folder with that source's data at Remote's UI.

In some embodiments, the sensor system may monitor the health condition (e.g., vital signs, blood glucose levels) for John Doe. In this case, John Doe is the patient, “remote” is a health-care provider, and the custom folder contains John Doe's patient data relating to the condition being monitored. While John Doe's health is published via presence information to “remote”, only his generic presence is published to his usual contacts such as Susan. Customization of the IM application matched to end-user roles and responsibilities provides just the level of detail on sensor measurements as needed for a given end-user.

### Use of Customized Messaging and Extended Presence Information for Communicating Remote Sensor Status Updates

While IM is typically used for interactive chat, IM applications may also be leveraged to convey time critical sensor generated information. The sensor information is displayed at the recipient in the format as it is sent or using a dedicated application. In some embodiments, the customized IM described above is used to provide for remote sensor monitoring. Customization of an IM tool is provided that is appropriate for different end-user markets to provide additional functionality enabling real-time tracking for safety, security and improved productivity. Various systems and methods are provided that allow for the display of conditions corresponding to remote sensor measurements to the end-user via a customized instant messaging application. Although IM is used as an illustrative example, presence information may be conveyed using any other form of messaging protocol and application which supports extended presence.

The presence feature in IM is used to convey critical information from sensor measurements in a quick and effective manner, and the presence condition on the IM UI is automatically changed, based on the most recent sensor measurement. For the remote recipient who is interested in the measurements being made by the sensors, the changes in measurement are clearly visible on the IM tool, for example through a change to the avatar and the accompanying presence message.

In some embodiments, the sensor condition changes are transmitted in the form of presence update only to a subset of the IM member group. The presence condition related to a given sensor measurement may be published to a secure sub-group of the IM groups in the contacts list. This sensor condition is customized information that is implementation specific, varying depending on the end-user market (e.g., healthcare, law enforcement, facilities management, R&D environment) and interest.

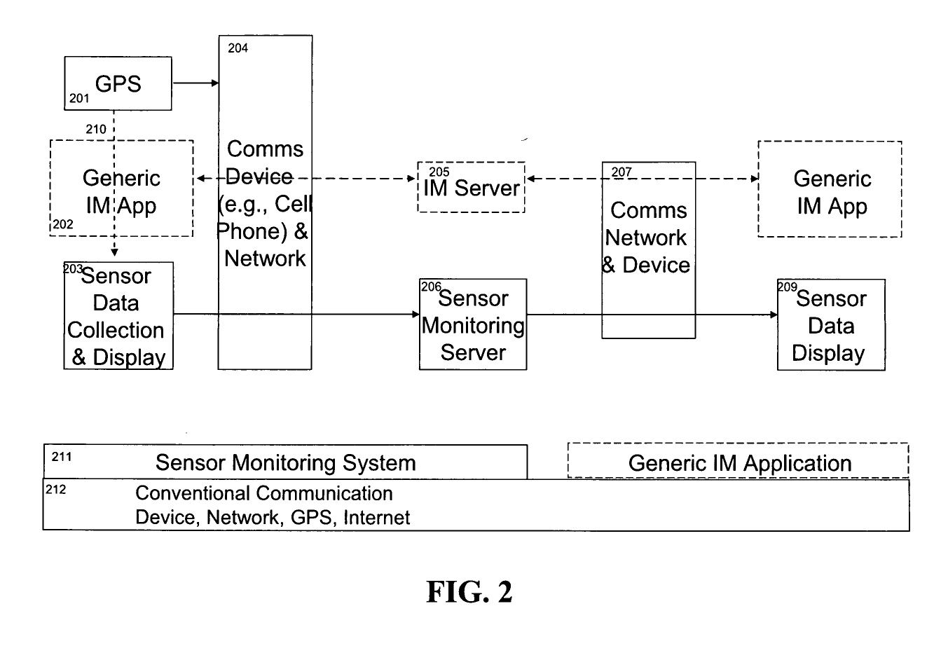

An illustrative system architecture for a remote sensor monitoring system is shown in FIG. 2. The system generally comprises of: a set of sensors for monitoring specified conditions and display (graphical user interface) at the sensor system end to show the real-time readings (203); a means (e.g., cellular SMS) to communicate the sensor data to a server (204); a sensor monitoring server which processes the information (206), applies the appropriate thresholds and generates summary results; a communication means for the server to communicate the summary results with the interested parties (207); and a display (GUI) at the interested end-user end to show the summary results (209). The remote sensor monitoring systems make use of any of the available applications to communicate data. In this figure, a conventional IM system at the sensor monitoring end (202) and a conventional IM system (208) at the recipient location is shown (shown with dotted lines to indicate that this is an optional function not associated with this system) for reference. There is no communication between the remote monitoring system and the IM application. The sensor monitoring system may also have a GPS capability (201) (e.g., for mobile sensors) which may optionally be linked (210) to the sensor data collection system. In summary, the remote sensor monitoring system (211) is a set of hardware (sensors/processors, server) and software (sensor data collection & display) which interfaces with the communication system (212) for transmission of sensor data to the remote sensor monitoring server and from the server to the end-user device. The end user may be operating a generic IM application (213, 214) completely independent of the sensor system application. When the end-user detects a problem in the system being monitored by the sensors based on reported data, he may take the requisite measures to deal with the problem.

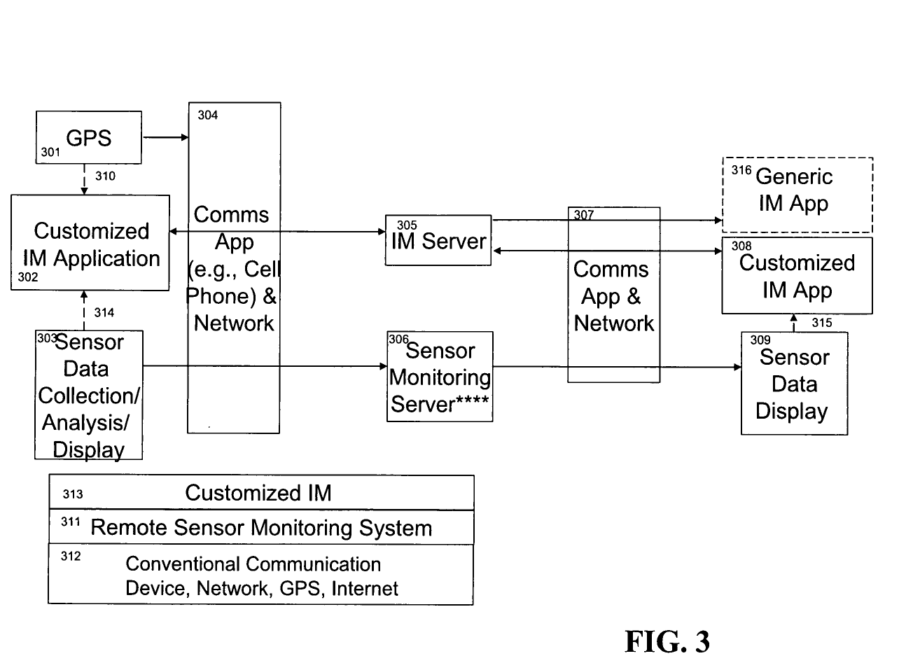

According to an embodiment of the invention, the system architecture is given in FIG. 3 for the customized IM application. The boxes other than boxes 302 and 308 perform the same function corresponding to those in FIG. 2, except for boxes 301 and 303 performing additional communications with the IM application. Boxes 302 and 308 are enhanced IM applications to represent real-time sensor measurement information in addition to conventional IM information. In order to assist with this, the GPS unit (301) and the sensor data collection & display unit (303) communicate with the IM application (see 310 and 314 respectively) to transfer relevant information. The extended presence information is updated in the customized IM application 302 which sends the information via the IM infrastructure to the customized IM application 308 (for one or more IM receiving devices). Various examples of the nature of this information are provided below. In some embodiments, the customized IM application (302/308) display provides time critical summary information, and the sensor system display (303/309) may be referred to for graphical data and further details. In another embodiment, the remote end only has the generic IM application (316) in which case only the custom avatar and presence update is available on the generic IM application.

In some embodiments, the remote sensing system is to track the health of a mobile patient using a set of medical sensors. Remote patient monitoring systems that are now commercially available are structured as described in FIG. 2. When the caregiver detects a problem in the patient's medical data by specifically looking at the patient condition display, he may contact the patient and advise changes to medication.
a) With the customized IM solution applied to this case as in FIGS. 3 and 4, a) the patient can have two avatars—one for friends, family and co-workers and another which is automatically controlled by the medical sensor system and only visible to a sub-group of caregivers (nurse, physician, selected family members); b) the patient is provided reminders and alerts on his IM application UI; c) the patient has access to a summary of recently measured sensor data in his custom data folder on his IM application; d) similarly, the remote recipient (caregiver) has access to real-time status of the patient with the automated changes to the avatar and extended presence data, and e) similar to the patient, the caregiver has a quick summary of one or more of his patients' condition on his IM display. Visual display of sensor condition with dynamic change of avatar provides a very concise and clear indication of important and critical changes in the environment being monitored by the sensor system. Such a solution makes it easier for the interested parties to access critical information and provide timely responses.

In another embodiment, the same approach presented is applied for use by personal trainers to monitor the conditions of athletes under their supervision.

In another embodiment of the invention, the same approach described above is applied to the monitoring of ambient conditions, appliances and devices. This may find application for sensors in the home and/or in an automobile to name a few specific examples. As will be apparent to one of ordinary skill in the art, the system described in FIG. 3 is appropriately set up to capture data from sensors in the home and automobile. A GPS unit is associated with the automobile. This will alert the owner to thefts and power outages, and also whether an appliance has been accidentally left on or has been turned on as pre-scheduled.

In an alternate embodiment of the invention, the enhanced IM application may be used in the area of business continuity planning. Real-time information about the security of installations and offices is critical for rapid intervention and for minimizing loss of property and assets including human assets. What is the impact on installations in the event of a power outage, say on a weekend? The backup power maintains minimal lighting, air conditioning and critical lab equipment for a period of time. If the air conditioning dies and the lab equipment stays on, the overheating from the operation of this equipment with insufficient cooling can cause further complications. It is necessary to estimate the impact of the power outage on IP phone lines that are no longer operable in the absence of power. It is important for management and business continuity planning teams to be notified in real-time in the case of such events. Remote sensors tracking the different critical parameters regarding the health of an installation can then convey changes to the conditions wirelessly via a change in avatar at the IM UI for all members of the business continuity team. In this case, the avatar and presence information does not reflect the condition of an individual, but rather of a facility or device, or multiple facilities or devices.

The IM communication may be enabled through a wired or wireless communication network. The device on which the IM communications is conducted may be any type of communication device (e.g., PC, laptop, PDA, cell phone) supporting IM.

In other embodiments, sensor measurements are made remotely in the form of equipment usage status, for example laboratory equipment usage (available, busy), and are made available in real time to individuals who are waiting to use the equipment.

In some embodiments, the systems and methods described are applied for a finite set of remote sensors to monitor certain conditions and the real-time results from the remote sensors, and provide this to certain entities, for example those entities with a responsibility for the conditions being monitored. Numerous other areas of application will emerge as sensors get deployed more broadly.

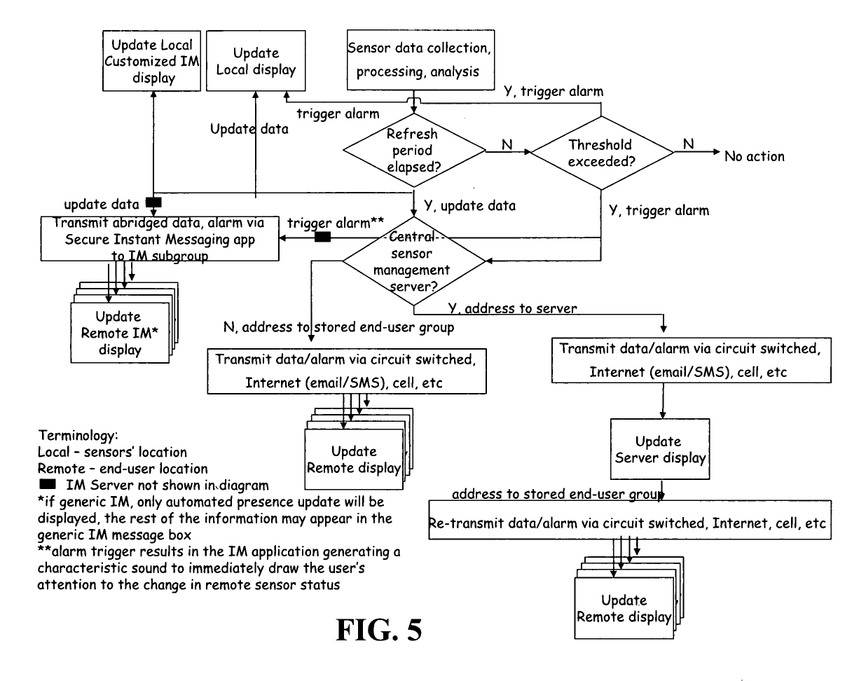

FIG. 5 is a flowchart of a method of using customized IM displays to convey remote sensor monitoring information. Boxes 501 to 505 represent the local functions. Boxes 501 to 504 comprise functions performed in a sensor system. Box 505 represents the customized IM application which interfaces with the sensor system. The actions triggered by box 502 and 504 are fed to the sensor system management server (box 506). Boxes 509 to 514 represent the actions taken by the sensor system management to deliver the information to a central location where the sensor system manager resides as well as to the remote end users. Updates and alarm triggers triggered by boxes 502 and 504 in the sensor system are also fed to the local customized IM application as well as to the customized IM applications (508) of remote users identified in a subgroup at the local end via a secure IM system (507). If the remote end user operates a generic IM application, only the automated presence update will be displayed, and the rest of the information may appear in the generic IM message box. The alarm trigger (generated from box 504) results in the IM application generating a unique sound along with a popup window on the user's display to immediately draw the user's attention to the change in avatar and presence condition corresponding to the change in remote sensor status. To ensure that the user responds appropriately to such a change, the popup window cannot be closed by the recipient, unless the requisite action required in response to the change is completed. From the user's perspective, sensor generated measurements received and displayed in a concise manner within the IM application can result in an efficient means of accessing and responding to time-critical events.

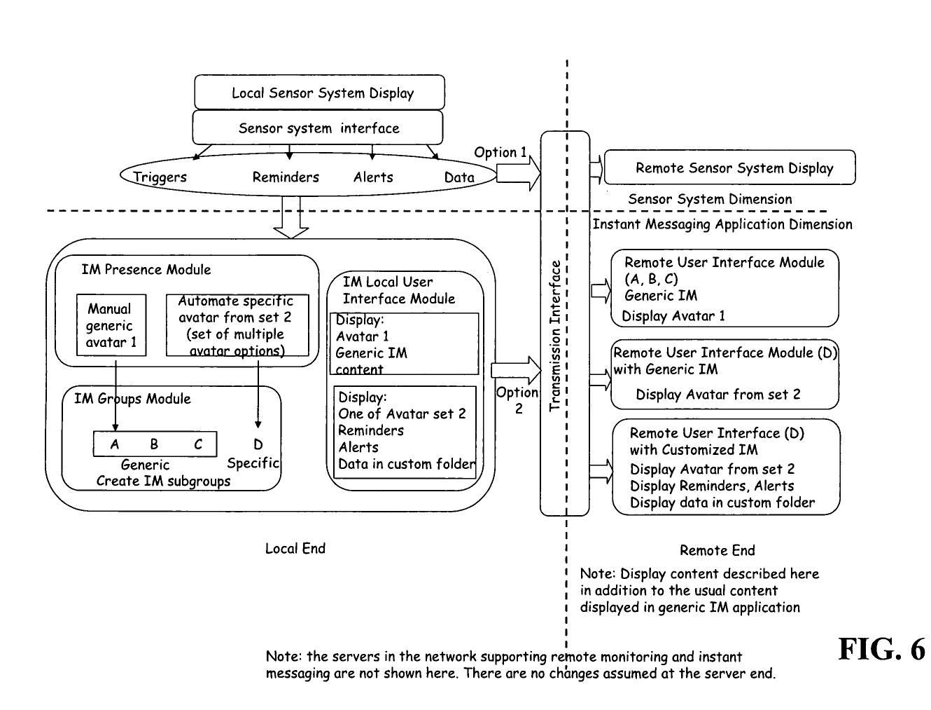

FIG. 6 is a block diagram of an example of customized IM application for conveying remote sensor monitoring information. The sensor system dimension and the instant messaging application dimension at the local and remote ends are shown in this figure. Boxes 601 to 603 represent the sensor system at the local end and box 604 represents the sensor system at the remote end. The (box 603) triggers, reminders, alerts and data generated by the sensor system at the local end may be communicated via some transmission interface (box 605) and displayed at the remote end using either or both of two options. Option 1 represents the information conveyed and displayed (box 604) by the existing sensor system mechanism. Option 2 represents the information conveyed and displayed by the customized IM application mechanism. The modifications needed to the IM application module (box 606) at the local end are shown in Boxes 607 to 609. The IM presence module (box 607) contains the generic avatar and associated presence information (box 610) as well as a custom avatar set (box 611) of which one specific avatar is displayed in accordance with the sensor system generated updates, along with the appropriate basic or extended presence information (e.g., low blood glucose level). The IM groups module (box 608) comprises a generic set of IM subgroups and a custom IM subgroup. The association between the two types of avatars and associated presence information generated by box 607 is shown with the arrows to the elements of box 608. The IM local user interface module (box 608) displays the generic avatar (612) as well as the specific current avatar (613) from the custom set, in addition to displaying reminders, alerts and data in the custom folder. The IM application dimension at the remote end is displayed in boxes 614 to 616. The display content described in boxes 614 to 616 is in addition to the usual content displayed in a generic IM application. If the remote user is from the generic IM subset only the generic avatar is displayed (box 614). If the remote user is from the custom IM subset but only has the generic IM application, then only the custom avatar and requisite presence information is displayed (box 615). If the remote user is from the custom IM subset and has the custom IM application, then the custom avatar and the corresponding presence information is displayed (box 614) along with reminders, alerts and the custom folder containing details of the sensor system status. The remote user may be associated with multiple custom contacts. In this case, the remote user will see multiple custom avatars (e.g., corresponding to multiple facilities being managed) as well as reminders, alerts and the custom folder corresponding to the highlighted user (e.g., facility) of immediate interest. The information available to the remote user will enable the user to take relevant action in accordance with the displayed information. This may include action on the sensor system such as re-calibration or sensor system management, which may be performed by means of IM (since it is a two-way communication system) or by other means.

It will be apparent to one skilled in the art that the instant messaging communication protocol supporting extended presence is only one way in which presence can be used to convey sensor measurement updates. Any messaging application with the ability to convey presence information can be used, provided that the sensor measurement changes are mapped to appropriate presence conditions.

From the description above, a number of advantages of some embodiments become evident:
b) Convenient availability of user presence information and ease of use for efficiently monitoring environments with sensor related measurements. From the user's perspective, displaying sensor generated measurements in a concise manner within the IM application can result in an efficient means of accessing and responding to time-critical events.
c) Simultaneously generating or displaying one of multiple presence conditions from the same source, where one of the presence conditions is induced by the status of the sensor system associated with that source, enables user(s) to have a single application for casual communications with contacts which can simultaneously be used to access to the status of critical changes to environment(s) or assets of interest being monitored.
d) Visual display of sensor condition via the dynamic change of avatar provides a very concise and clear indication of important and critical changes in the environment being monitored by the sensor system.
e) Customization of the messaging application matched to end-user roles and responsibilities provides just the level of detail on sensor measurements as needed for a given end-user.
f) By ensuring that critical changes to presence conditions are appropriately acted upon before the presence update notification is dismissed from the end-user's screen, the application buffers against the risk of missing time-critical action in response to a change in condition in the environment being monitored.

### Conclusions, Ramifications and Scope

Accordingly, the reader will see that the customized instant messaging application supporting extended presence provides a convenient and efficient solution for displaying status of measurements from sensors monitoring environment(s) of interest to a group of stakeholders. By extending the functionality of a commonly used messaging application for person-to-person communications to include machine-to-person communications, a convenient solution is provided to access critical changes to environment. Furthermore, the use of extended presence protocols in the messaging application to convey important changes to sensor data has additional advantages in that:
it provides very concise and clear indication of important and critical changes in the environment being monitored by the sensor system with visual display of sensor condition with dynamic change of avatar and extended presence update;
it provides just the level of detail on sensor measurements as needed for a given recipient with customization of the content delivered to match recipient roles and responsibilities; and
it buffers against the risk of missing time-critical action in response to a change in condition in the environment being monitored by allowing dismissal of presence update notification from the recipient's screen only after ensuring that critical changes to presence conditions are appropriately acted upon.

Numerous modifications and variations of the present invention are possible in light of the above teachings. It is therefore to be understood that within the scope of the appended claims, the invention may be practiced otherwise than as specifically described herein.

We claim:

1. A method comprising:
defining a plurality of icons and associated presence content, and for each icon defining a respective sub-group of contacts for which the given icon is applicable;
conveying each of the plurality of icons to the respective contact group for display.

2. The method of claim 1 further comprising:
using at least one of the icons to convey status of measurements from remote sensors.

3. The method of claim 1 further comprising:
obtaining a sensor measurement;
changing at least one of the icons dynamically in response to the sensor measurement.

4. A method comprising:
receiving and displaying a generic icon for some IM devices;
receiving and displaying a custom icon for some IM devices.

5. The method of claim 4 further comprising:
receiving sensor related information from at least one remote sensor;
displaying the respective custom icon together with at least some of the sensor related information;
displaying sensor related information in a separate window until requisite follow-up action is taken in response to sensor information update.

6. The method of claim 4 further comprising:
provisioning the messaging application with a data summary containing a list of important remote sensor measurements.

7. A computer readable medium having computer executable instructions for executing the method of any one of claims 1 to 6.

8. A computer readable medium having computer executable instructions for executing the method of any one of claims 1 to 3 in a presence status publishing role, in combination with the method of any one of claims 4 to 6 in a presence status receiving role.

9. A messaging capable device operable to implement the method of any one of claims 1 to 7.

10. A system comprising:
a remote sensor measurement system, operable to collect, analyze, display and transmit measurements, the sensor measurement system having an interface with a first custom messaging application to transfer summary data from the remote sensor measurement system;
the first custom messaging application further operable to publish different presence conditions to different recipient groups; and
the first custom messaging application being further operable to change and publish specific presence condition automatically in response to specific input from remote sensor measurement system.

11. The system of claim 10 further comprising:
a location measurement device operable to measure location in the case of moving remote sensors.

12. The system of claim 11 further operable to perform at least one of:
receive content from the remote sensor measurement system;
display the content within the messaging application to a subset of recipients;
generate multiple presence conditions;
display alerts and reminders on user interface;
display further details on the sensor measurements in folders contained within the user interface.
